(19) United States
(12) Patent Application Publication
(10) Pub. No.: US 2024/0170939 A1
(43) Pub. Date: May 23, 2024

(54) METAL TO METAL ENCAPSULATED ELECTRICAL POWER CABLE SYSTEM FOR ESP AND OTHER APPLICATIONS

(71) Applicant: BIM2M-ESP LIMITED, Glasgow (GB)

(72) Inventor: Philip HEAD, Berkshire (GB)

(21) Appl. No.: 18/553,287

(22) PCT Filed: Mar. 31, 2022
(86) PCT No.: PCT/GB2022/050821

§ 371 Date: Sep. 29, 2023

(30) Foreign Application Priority Data
Mar. 31, 2021 (GB) 2104638.8

(51) Int. Cl. H02G 15/013; H02G 9/06; H02G 9/10

(52) U.S. Cl. CPC H02G 15/013; H02G 9/06; H02G 9/10

(57) ABSTRACT

A method of sealing a downhole electrical cable, comprising a chamber around the downhole electrical cable defined by a sleeve or outer body member introducing metal alloy into the chamber melting the metal alloy, allowing the molten alloy to set such that the electrical cable is encapsulated by the set molten alloy and sealed from the well environment.

An Electrical Submersible Pumping (ESP) system is an artificial-lift system that utilizes a downhole pumping system that is electrically driven.

The pump typically comprises several staged centrifugal pump sections that can be specifically configured to suit the production and wellbore characteristics of a given application.

Electrical submersible pump systems are a common artificial-lift method, providing flexibility over a range of sizes and output flow capacities.

A particular weakness of existing systems is that the power cable has to pass through several barriers, which results in a bulkhead and connectors which are either side of the bulkhead.

The barrier could be the wellhead, a downhole packer or the connection to the motor itself commonly called the pot head, it could also include changing from a round cable to a flat cable called a motor lead extension.

Inside an oil well, the pressures and temperatures can be very high, in addition, gases are vented and can penetrate the jacket of the power cable and migrate to the connector itself.

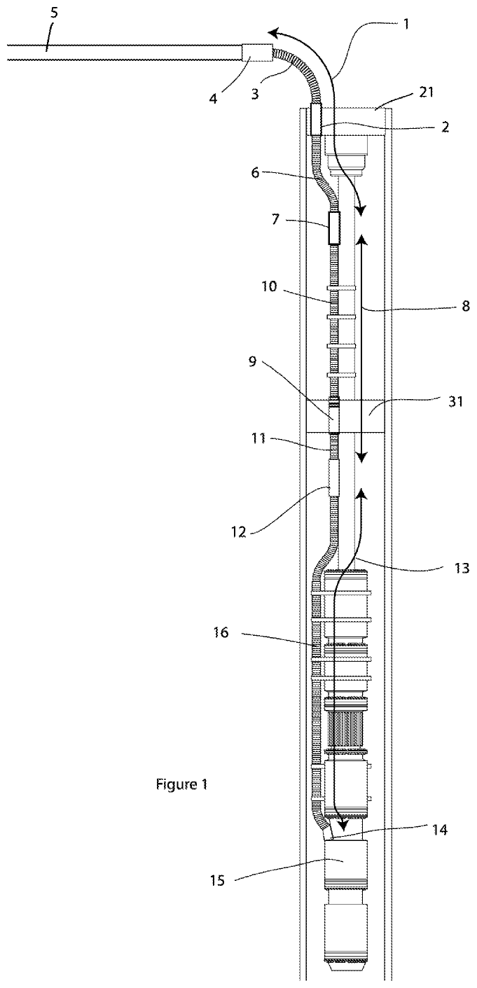

Saudi Aramco have identified for them that they can attribute 69% of there failures to the power cable system. (Ref: SAUDI ARAMCO JOURNAL OF TECHNOLOGY FALL 2016, page 15 FIG. 1.) This will be different for other operators but provides a sense of scale of the issue.

It is the purpose of the present invention to eliminate all electrical connectors regardless of the number of bulk heads the cable has to pass through

It is a further objective of the invention to have pre-assembled cable assemblies consisting of a penetrator body with the cable encapsulated in a low temperature alloy such as bismuth.

According to the present invention the cable assemblies are joined by a splice which is encapsulated in a low temperature alloy such as bismuth.

According to a further aspect of the invention the pot head is encapsulated in encapsulated in a low temperature alloy such as bismuth and includes an electric heating element which creates a metal to metal seal the housing of the motor.

According to a further aspect of the invention, a heater is embedded in the bulkhead

According to a further aspect of the invention, a heater is an external assembly to provide heat in a controlled way to make the bismuth molten, a retrievable temperature probe could precisely record the internal temperature.

According to a further aspect of the invention, a temperature sensor is part of the assembly and is recorded to a data logger

According to a further aspect of the invention, a rubber grommet is used to seal the base of the chamber the bismuth is made molten in.

According to a further aspect of the invention, the ends are cooled so when the low temperature alloy contacts the cooling material it solidifies immediately

According to a further aspect of the invention, the filling system is totally automatic and sealed

According to a further aspect of the invention, a pressure test port can be included to confirm the integrity of the metal-to-metal encapsulation

According to a further aspect of the invention the bismuth seals around the cable armour.

According to a further aspect of the invention the bismuth seals around the cable jacket.

According to a further aspect of the invention the bismuth seals around the individual cable conductors.

According to a further aspect of the invention the bismuth can be remelted to enable disassembly.

According to a further aspect of the invention a drain port is provided to enable the bismuth to be emptied from the chamber.

According to a further aspect of the invention the remelted bismuth can be recovered by drain ports.

According to a further aspect of the invention, different melting points of bismuth alloys can be selected depending on the anticipated well bore temperature.

The term low-temperature-alloy here means any alloy that is solid at the normal temperatures of a wellbore, but is molten at a relatively low temperature, particularly the temperature of common metals and alloys such as copper which is routinely used as a conductor in downhole environments.

Although low temperature alloys are strictly a mixture of two different metals or a metal and another element, pure bismuth could be used in any of the examples given.

The following is a more detailed description of an embodiment according to invention by reference to the following drawings in which:

FIG. 1 is a section side view of a well with an ESP assembly installed on tubing, and three cable assemblies identified.

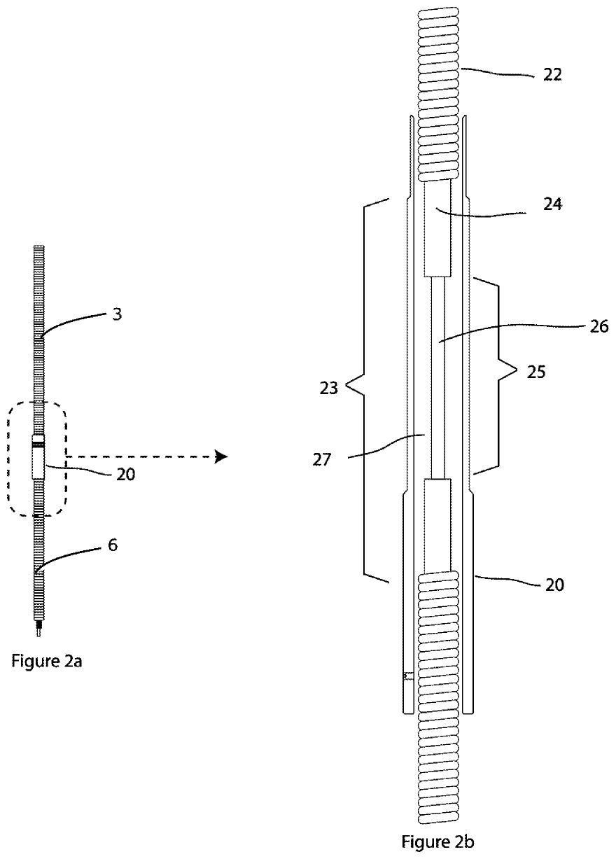

FIG. 2a,b is the wellhead cable assembly consisting of a metal to metal encapsulated penetrator and two cable pig tails extending from each end of the penetrator.

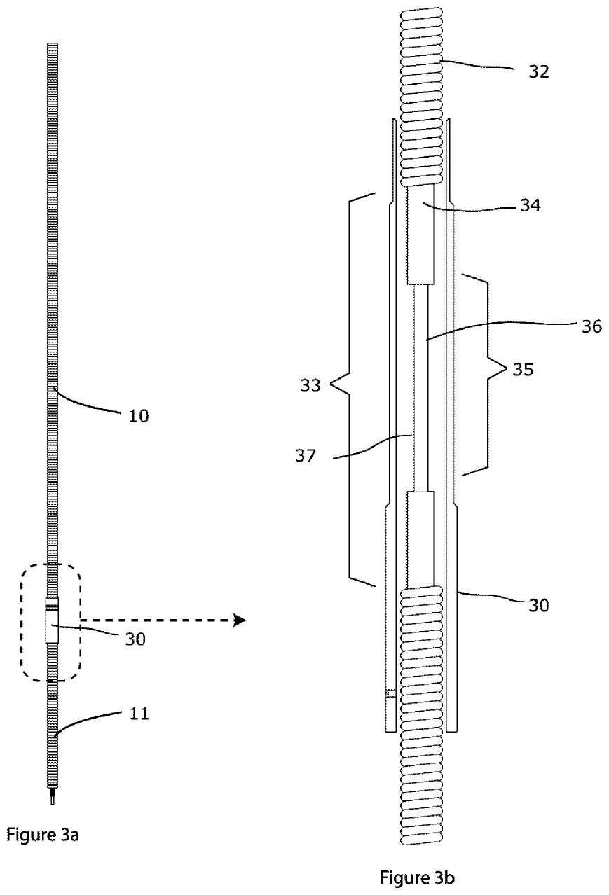

FIG. 3a,b is the packer cable assembly consisting of a metal to metal encapsulated penetrator and two cable pig tails extending from each end of the penetrator.

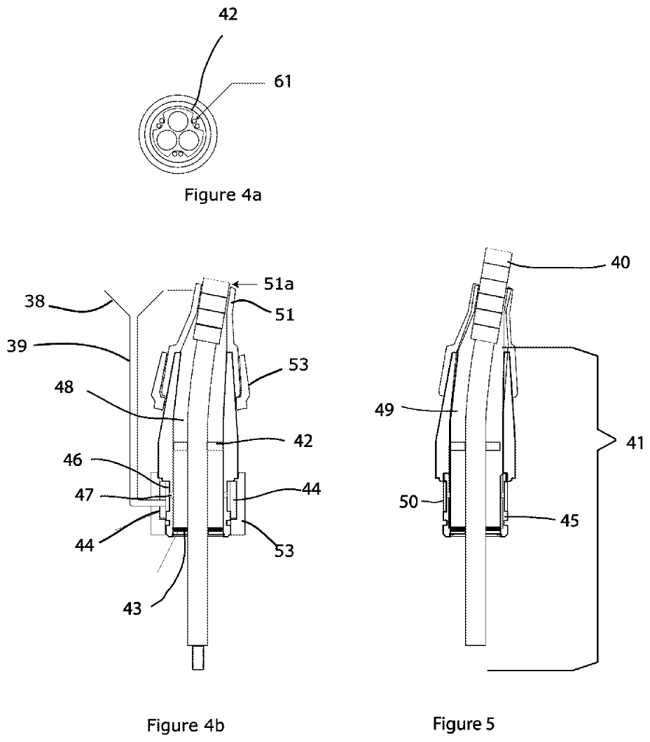

FIG. 4 is a section side view of a motor pot head, prior to being encapsulated with low temp alloy

FIG. 5 is a similar view to FIG. 4 after being filled with low temperature alloy

FIG. 6 is an external view of the pot head as shown in FIGS. 4 and 5

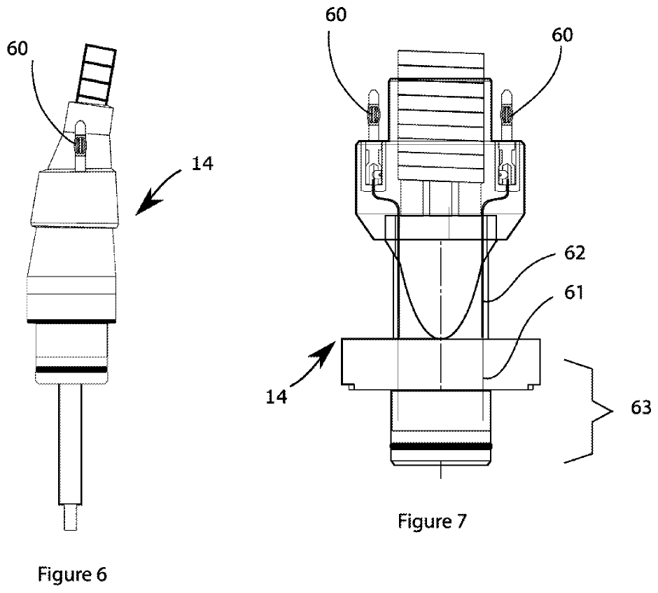

FIG. 7 is a front view of the pot head, with a electrical heating circuit identified

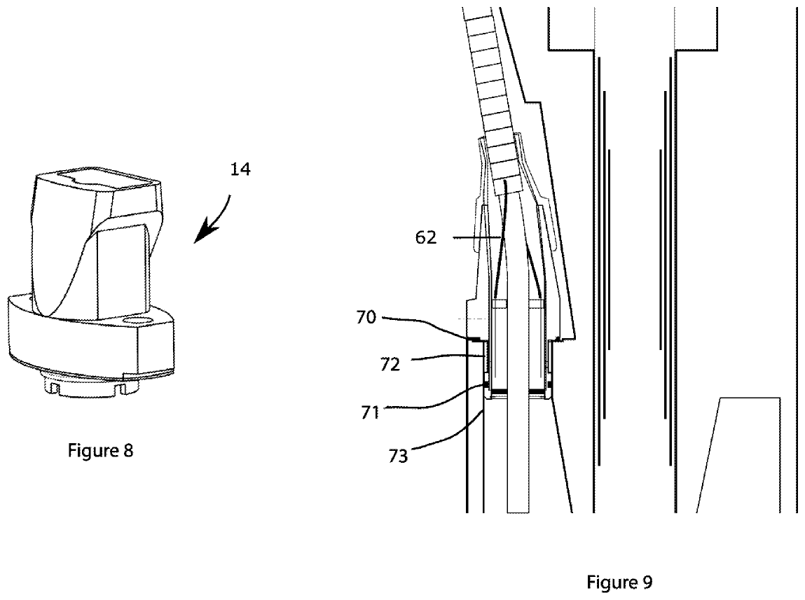

FIG. 8 is a standard pot head casing body

FIG. 9 is the pot head installed and the metal-to-metal seal to the motor body being achieved.

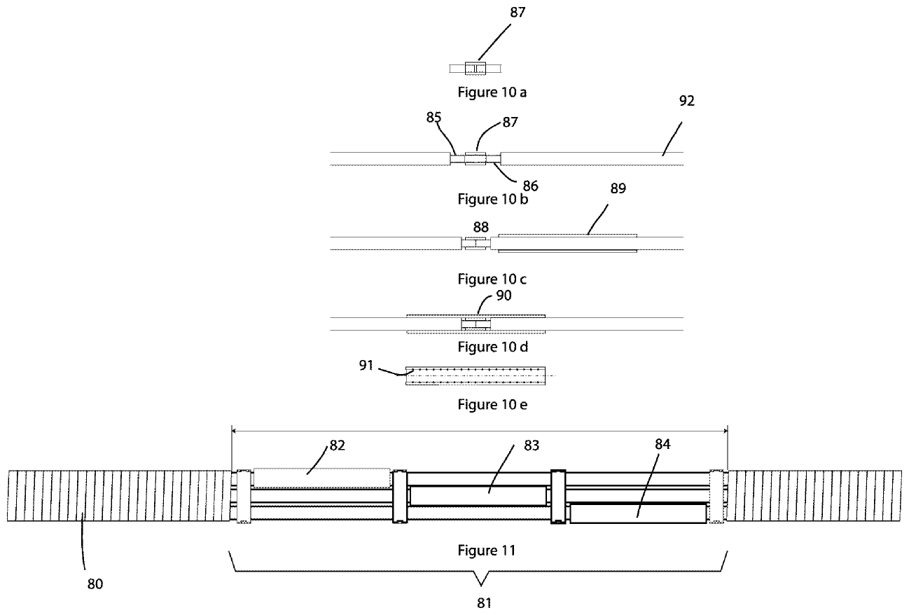

FIG. 10 a,b,c,d,e is the assembly of a splice

FIG. 11 is a 3-phase cable assembly splice, with the splices staggered, and centralisers fitted.

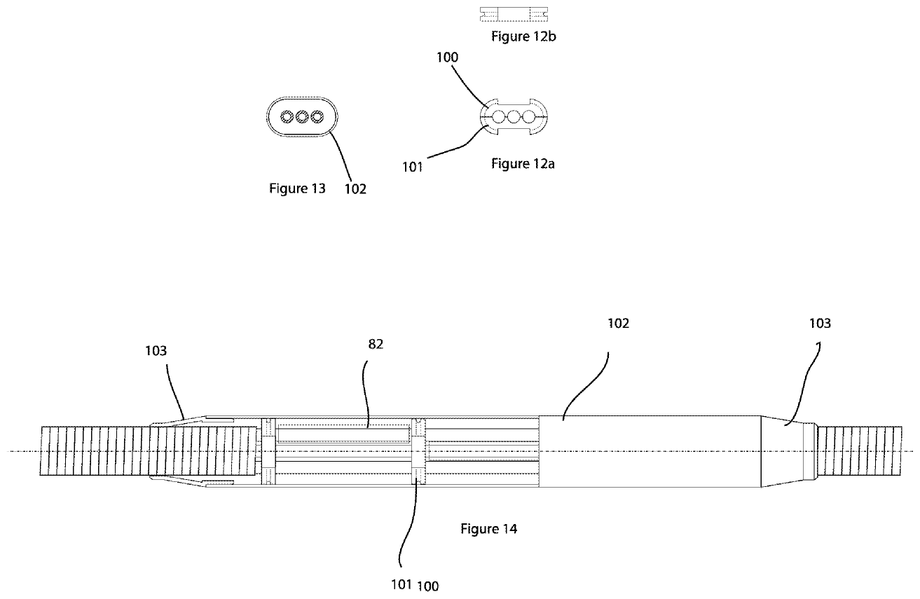

FIG. 12 a,b is a end and side view of the cable centraliser

FIG. 13 is a section side view through the splice tube

FIG. 14 is part section plan view of the splice cable inside a splice tube, with end caps fitted.

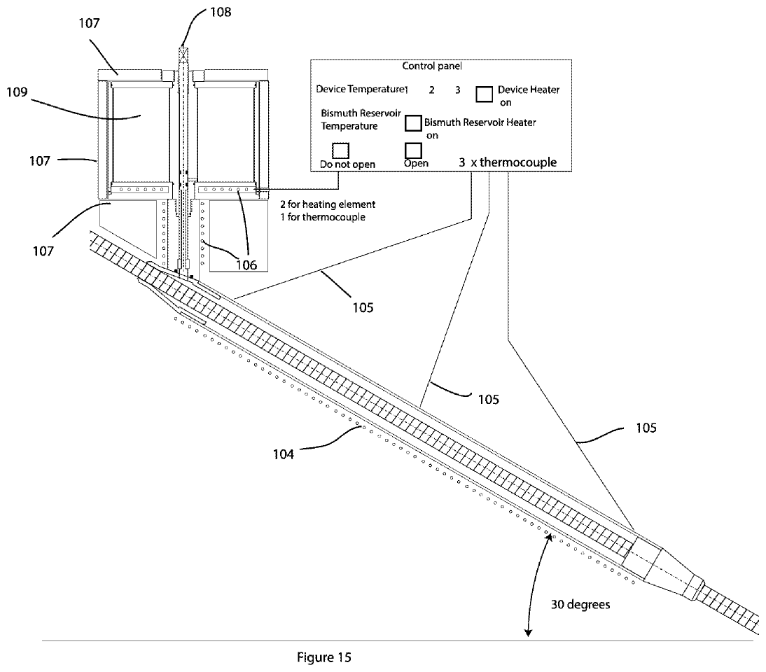

FIG. 15 is a section side view of an automatic low temperature filling system

Referring to FIG. 1, this is a section side view of a well with an ESP assembly installed on tubing, and three cable assemblies identified.

The wellhead cable assembly 1, has a wellhead penetrator body 2 encapsulated onto the power cable and an upper pig tail 3 being spliced 4 to the surface cable 5. The lower pig tail 6 is inside the well and is field spliced 7 to the packer cable assembly 8

The packer cable assembly 8, has a packer penetrator body 9 encapsulated onto the power cable and an upper pig tail 10 being spliced 7 to the wellhead surface cable 6. The lower pig tail 11 is below the packer and is field spliced 12 to the pot head cable assembly 13

The pot head cable assembly consists of metal encapsulated pot head 14, which terminates into to the motor 15, and has an upper pig tail 16 commonly called the motor lead extension, this is spliced 12 to the lower pig tail 11 of the packer cable assembly 8

Referring to FIGS. 2a and 2b, this shows in more detail the wellhead cable assembly. The penetrator body 20 locates in the tubing hanger 21. This is pressure bulkhead, typically, this consists of a sealed penetrator with connectors on each end.

An aspect of this invention is to eliminate as many connections as possible. The cable armour 22 is removed by a length 23, the cable jack 24 is removed by a length 25, to expose the three insulated conductors 26. This is positioned inside the penetrator body 20 and low temperature alloy fills all the free space 27, resulting in a metal-to-metal encapsulated wellhead cable bulkhead with no connectors.

Referring to FIGS. 3a and 3b, this shows in more detail the packer cable assembly. The packer penetrator body 30 locates in an offset bore in the packer hanger 31. This is pressure bulkhead, typically, this consists of a sealed penetrator with connectors on each end.

To eliminate as many connections as possible. The cable armour 32 is removed by a length 33, the cable jack 34 is removed by a length 35, to expose the three insulated conductors 36. This is positioned inside the penetrator body 30 and low temperature alloy fills all the free space 37, resulting in a metal-to-metal encapsulated wellhead cable bulkhead with no connectors.

Referring to FIGS. 4a to 9 there are shown details of the manufacture and assembly of the pot head. The armour 40 is removed a set distance 41, the three cables (here shown as a single cable for simplicity) pass through a centraliser 42, and then through a lower seal 43. A temporary elastomer seal 44 is placed around an extension tube 45, a recess 46 and passages 47 and the internal void 48 can then be filled with low temperature alloy 49 inside and 50 in the outer recess, introduced in a molten state via a filling apparatus comprising a funnel 38 and line 39. The upper cable seal 51 lets air vent 51a and allows the uniform filling of the void space. Once the low temperature alloy has cooled, the filling apparatus is removed and excess low temperature alloy recovered. Removeable gel packs 53 may be applied around the pot head to encourage the low temperature alloy to seal quickly.

Another feature of this pot head is it has an internal electric heating circuit, consisting of electrical connectors 60, and a nichrome heating element wire 61, which is electrically insulated its entire length, and thermally insulated 62 so when it is powered up it only heats the area 63. When the pot head is installed in the motor O rings 70, and 71 contain the bismuth in the recess 72. Because there had to be clearance to install it, at this stage there is no metal-to-metal seal with the motor housing 73. When it is fully installed, and retaining nuts made up to the correct torque, the heating system is powered up and the low temperature alloy becomes molten and the cavity 72 achieves a true metal to metal seal with the pot head and the motor housing. Another benefit of low temperature alloy is that when they solidify, the alloy expands between 0.75%-3% depending on its composition.

Referring to FIGS. 10 to 15 there is shown the assembly process for a field assembled metal to metal encapsulated splice.

The armour 80 is removed a set amount 81 from each pig tail to be spliced together. Each conductor is cut to a set length so that each splice is offset 82,83,84 from the others.

Each conductor to enhance the electrical contact, may be threaded 85, 86 with a right-hand and left-hand threads respectively, and a connecting sleeve 87 with matching threads when rotated will pull both cables together until they touch 88. This can then be crimped to provide even better contact. A Viton or other high temperature sleeve 89 can be slid over the splice 90. Inside the sleeve are ribs 91 which form pressure tight contact to the lead jacket 80 of the conductor.

To ensure the conductors are evenly spaced, a two-piece centraliser 100,101 clips around the conductor, so that they correctly positioned inside the splice tube 102 The slice tube is slid over the splice assembly and end caps 103 fitted

A heating element 104 heats the tube 102 up to the melting point of the low temperature alloy, the temperature is regulated by thermocouples 105. A second heating element 106 heats a sealed thermally insulated 107 bismuth chamber, when the bismuth is molten 109 a valve 108 is opened and bismuth fills all the void space inside the tube 102 with molten bismuth, again as already described as it cools it expands and energises the sealing of the metal encapsulation. After the low temperature alloy has been introduced, the valve 108 may be closed to seal the discharge hole.

All the splices, penetrator connections and pot head connections are here described as being sealed with a metal-to-metal connection using bismuth of similar low melting point alloy, however it will be realised that particular splices, penetrator connections and pot head connections and other types of connection could be selected on an individual basis as required.

Temperature and/or pressure probes could be incorporated in the chamber into which the low temperature alloy is to be poured; further, any such probe would be recorded to a data logger.

1. A method of sealing a downhole electrical cable, comprising:
providing a chamber around the downhole electrical cable defined by a sleeve or outer body member;
introducing metal alloy into the chamber;
melting the metal alloy; and
allowing the molten alloy to set;
such that the electrical cable is encapsulated by the set molten alloy and sealed from the well environment.

2. A method according to claim 1, wherein the electrical cable comprises a first electrical cable having an end with a first exposed conductive surface and a second electrical cable having an end with a second exposed conductive surface abutting the first exposed conductive surface of the first electrical cable with the second exposed conductive surface of the second electrical cable so that a conductive path is provided between the first electrical cable and second electrical cable such that the first and second electrical cables are conductively spliced once after the molten alloy has set.

3. A method according to claim 2, wherein the electrical cable penetrates a bulkhead.

4. A method according to claim 3, wherein the bulkhead includes a heating element.

5. A method according to claim 1, wherein the sleeve or outer body member having an inlet.

6. A method according to claim 1, wherein the electric cable is introduced to a downhole device through a pot head, and an electric heating element is included in the pot head.

7. A method according to claim 1, wherein the electrical cable includes cable armour, and the metal alloy seals around the cable armour.

8. A method according to claim 1, wherein the electrical cable includes a cable jacket, and the metal alloy seals around the cable jacket.

9. A method according to claim 1, wherein the electrical cable comprises more than one individual cable conductors, and the metal alloy seals around the individual cable conductors.

10. A method according to claim 1, wherein an external assembly provides heat in a controlled way to make the metal alloy molten.

11. A method according to claim 1, wherein a temperature and/or pressure probe is incorporated in the chamber.

12. A method according to claim 1, wherein a temperature sensor is part of the assembly and is recorded to a data logger.

13. A method according to claim 1, wherein a rubber grommet is used to seal a base of the chamber the metal alloy is made molten in.

14. A method according to claim 1, wherein a pressure test port is included to confirm the integrity of the metal-to-metal encapsulation

15. A method according to claim 1, wherein metal alloy is remelted to enable disassembly.

16. A method according to claim 1, wherein a drain port is provided to enable the metal alloy to be emptied from the chamber.

17. A method according to claim 16, wherein remelted metal alloy is recovered by drain ports.

18. A method according to claim 1, wherein a particular melting point metal alloy is selected depending on an anticipated well bore temperature.

19. A method according to claim 1, wherein the metal alloy includes bismuth.
